(19) United States
(12) Patent Application Publication
(10) Pub. No.: US 2007/0103277 A1
(43) Pub. Date: May 10, 2007

(54) Security system enhancement device key

(75) Inventors: Howard Yuk, East Meadow, NY (US); Tony T. Li, Roslyn Heights, NY (US); Albert Lee, Brooklyn, NY (US)

Correspondence Address: Honeywell Law Department;Patent Services, AB-2, 101 Columbia Road, P.O. Box 2245, Morristown, NJ, 07962-2245, US

(73) Assignee: Honeywell International, Inc., Morristown, NJ (US)

(21) Appl. No.: 11/270,176

(22) Filed: Nov. 9, 2005

(51) Int. Cl. B60R 25/10; H04L 9/32; G05B 19/00

(52) U.S. Cl. 340/426.35; 340/5.22

(57) ABSTRACT

A system for enabling or disabling one or more security system features of a security system platform allows manufactures to produce one security system platform. Such a system includes a controller configured for controlling the one or more security system features and an interface in communication with the controller. The system further includes an electronic device key for storing configuration data, the electronic device key being configured to electrically mate with the interface to establish communication between the electronic device key and the controller to transmit the configuration data to the controller to instruct the controller to enable or disable the one or more security system features of the security system platform.

### TECHNICAL FIELD

The invention relates generally to security systems, and more particularly to a security system including a device key for enabling or disabling various security system features.

### BACKGROUND INFORMATION

Typically, manufactures of security systems provide various models of security systems ranging from a basic model with a few features and protection levels to a deluxe model with many features and many, higher protection levels. Two main problems exist with this approach. First, only a portion of each system includes components are common to all the models, while other components are specific to a particular model. This results in manufacturing inefficiency. Second, when a customer wants to upgrade his existing security system, all or part of the existing security system must be replaced with new equipment. This process is both time consuming and costly.

### SUMMARY OF THE INVENTION

The invention relates generally to security systems, and more particularly to a security system including a device key for enabling or disabling various security system features.

In one aspect, the invention involves a system for enabling or disabling one or more security system features of a security system platform. The system includes a control means configured for controlling the one or more security system features, an interface means in communication with the control means, and an electronic device key including a means for storing configuration data. The electronic device key is configured to electrically mate with the interface means to establish communication between the electronic device key and the control means to transmit the configuration data to the control means to instruct the control means to enable or disable the one or more security system features of the security system platform.

In some embodiments, the means for storing the configuration data includes a microprocessor and/or flash memory. In another embodiment, the configuration data is encrypted. In one embodiment, the electronic device key communicates with the control means via an encrypted communication protocol. In yet another embodiment, the control means stores a unique identifier in a protected memory location on the electronic device key thereby configuring the electronic device key to function exclusively with a particular security system platform. In still another embodiment, the control means stores a unique identifier on the electronic device key thereby configuring the electronic device key to function with a plurality of security system platforms. In other embodiments the interface means includes an electrical pin header or an electrical socket, and the control means includes a microprocessor. In another embodiment, the electronic device key includes an electrical connector for electrically mating with the interface means.

In another aspect, the invention involves an electronic device key for enabling or disabling one or more security system features of a security system platform. The electronic device key includes a body portion defining a cavity, a means for storing configuration data disposed in the cavity, and a connector portion coupled to the body portion and in electrical communication with the means for storing configuration data. The connector portion is configured to electrically mate with an interface means that is in electrical communication with a control means that controls the security system platform to communicate the configuration data to the control means to instruct the control means to enable or disable the one or more security system features of the security system platform.

In some embodiments, the means for storing the configuration data includes a microprocessor, and the means for storing configuration data includes a flash memory.

In still another aspect, the invention involves a method for enabling or disabling one or more security system features of a security system platform. The method includes providing control means configured for controlling the one or more security system features, and providing and interface means in communication with the control means. The method further includes providing an electronic device key that includes a means for storing configuration data. The electronic device key is configured to electrically mate with the interface means to establish communication between the electronic device key and the control means to transmit the configuration data to the control means to instruct the control means to enable or disable the one or more security system features of the security system platform.

The foregoing and other objects, aspects, features, and advantages of the invention will become more apparent from the following description and from the claims.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention.

FIG. 1 is an illustrative perspective view of a security system chassis including a motherboard, according to one embodiment of the invention.

FIG. 2A is an illustrative front view of a security system chassis, according to another embodiment of the invention.

FIG. 2B is an illustrative side view of the chassis shown in FIG. 2A, according to still another embodiment of the invention.

FIG. 3 is an illustrative schematic top view of a motherboard, according to one embodiment of the invention.

FIG. 4 is an illustrative side view of a device key, according to one embodiment of the invention.

FIG. 5 is an illustrative cross-sectional view of the device key shown in FIG. 4, according to another embodiment of the invention.

FIG. 6 is an illustrative side view of a motherboard including an interface port, according to still another embodiment of the invention.

FIG. 7 is an illustrative side view of a motherboard shown in FIG. 6 including a device key connected to the interface port, according to another embodiment of the invention.

### DESCRIPTION

The invention relates generally to security systems, and more particularly to a security system including a device key for enabling or disabling various security system features. The invention enables a security system manufacturer to produce a single security system platform with a single set of security features, rather than a number of security system platforms, each with a different set of security features. Customers configure the single security system platform based on their individual needs via an electronic device key, which enables or disables the various security system features accordingly.

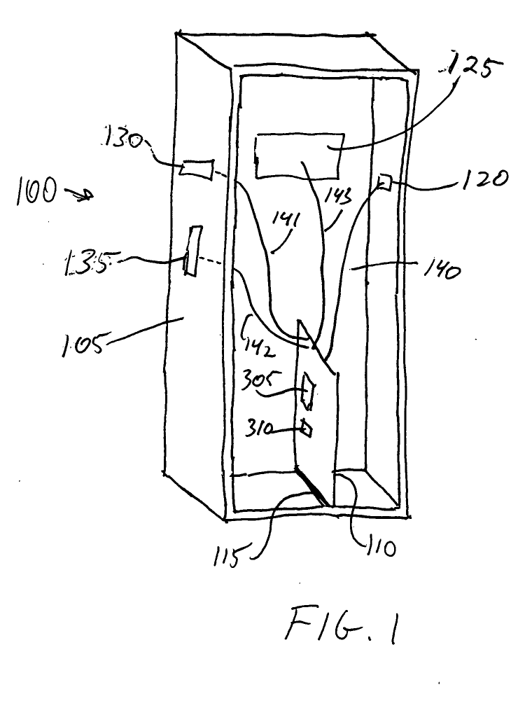

Referring to FIG. 1 in one embodiment, the invention is implemented in a security system platform 100, which includes a component cabinet or chassis 105. The chassis 105 houses a motherboard 110, which is disposed vertically within the chassis 105 in a slot or socket 115. In other embodiments, the motherboard 110 is disposed horizontally within the chassis 105. The chassis 105 further includes a display/control panel 125, one or more connectors 120, 130, 135 for connecting to various security devices (not shown) such as cameras, monitors, alarms, keypads, telephone lines, wireless communication devices, and electronic door locks, for example. The connectors 120, 130, 135 and the display/control panel 125 are also connected to the motherboard 110 via cables 140, 141, 142, 143, respectively. The motherboard 110, via the display/control panel 125, controls the various security devices. The motherboard 110 also includes a microprocessor 305 and a header or interface port 310, and other various electronic components, and will be discussed in further detail below.

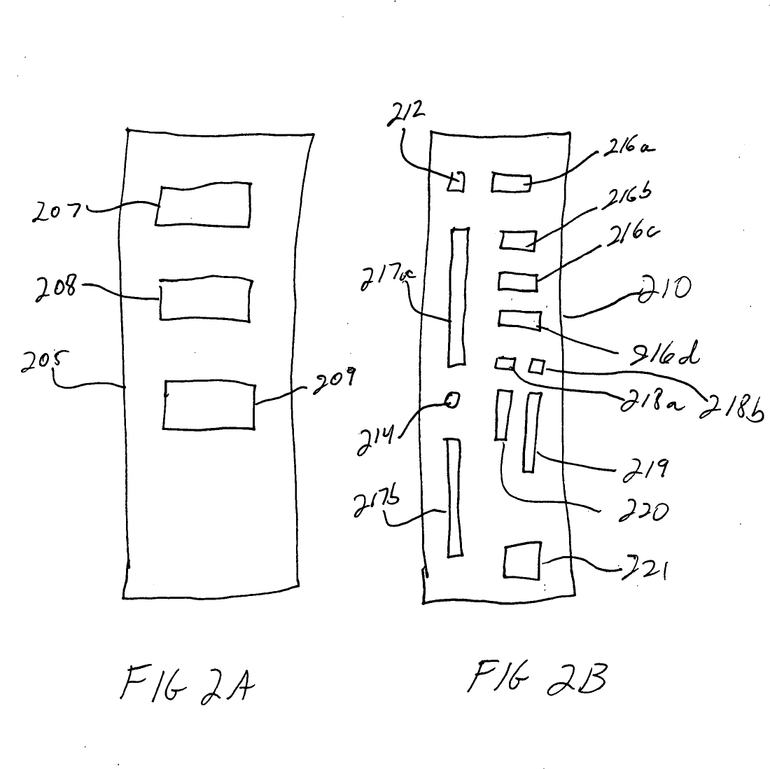

Referring to FIGS. 2A and 2B, in alternative embodiment, a front panel 205 of the chassis 105 includes multiple display and control panels 205, 207, 208. Further, a side panel 210 of the chassis 105 includes various connectors 212, 214, 216a-c, 217a-b, 218a-b, 219, 220, 221, which can include serial ports, parallel ports, BNC connectors, Ethernet connectors, a phone jack, DB connectors with various pin counts, or any other type of electronic connector known in the art that is suitable for interfacing with various security devices.

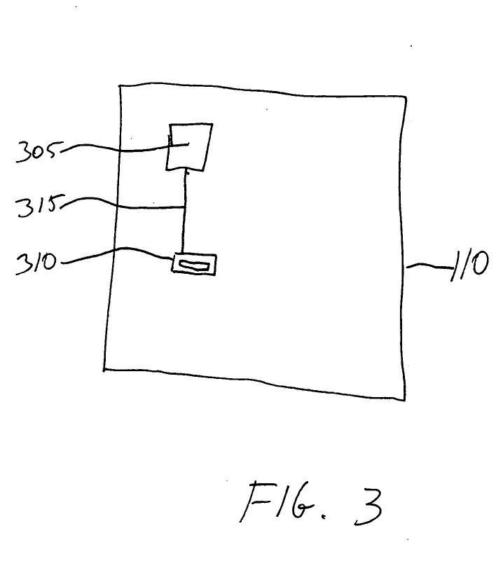

Referring to FIG. 3, in one embodiment, the motherboard 110 is a typical printed circuit (PC) board and includes a microprocessor 305 in electrical communication with a header or interface port 310 via signal path 315 (e.g. wires or PC traces). The microprocessor 305 is the brain of the security system 100 and controls all of the various security features and security devices connected to the chassis 105.

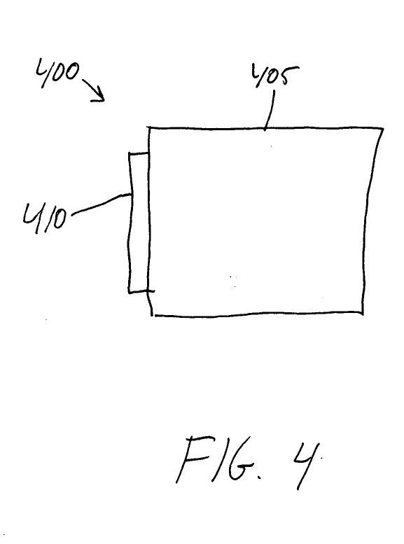

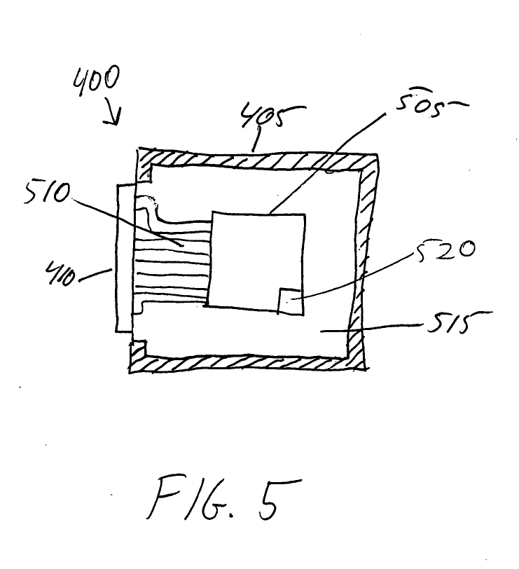

Referring to FIGS. 4 and 5, in one embodiment, an electronic device key 400, such as a dongle is shown. The electronic device key 400 includes a body portion 405 and a connector 410. The body portion 405 defines a cavity 515, which houses a microprocessor 505, (or flash memory, or both). In one embodiment, the microprocessor includes on-chip memory 520. In another embodiment, external memory is housed in the cavity 515 and is in electrical communication with the microprocessor 505.

The microprocessor 505 is in electrical communication with the connector 410 via signal path 510. The connector 410 can be any type of connector that is suitable for electrically mating with the interface port 310. The interface port 310 includes a power and ground connection that provides power and ground to the microprocessor 505 (or flash memory) in the electronic device key 400 when the electronic device key 400 is electrically mated to the interface port 310.

A security system configuration data file is stored on the microprocessor 505 on-chip memory 520 (or flash memory), or on memory associated with, and in communication with, the microprocessor 505. The configuration data file is used to configure the security system platform 100 by providing instructions to the microprocessor 305 regarding enabling or disabling various security system features. Further, the configuration data file stored on a particular electronic device key 400 is unique and is its contents is determined by the particular security system features to be enabled or disabled. The security system features that are enabled or disabled are determined by a customer's particular security needs. More specifically, the customer selects a subset (or the total set) of security features from the total set of security features available on the security system platform 100. The security features selected will determine the particular configuration data file that is stored on the electronic device key 400.

After the electronic device key 400 is mated with the interface port 310, the configuration data file is transmitted (downloaded) to the microprocessor 305 on the motherboard 110. The microprocessor 305 uses the information in the configuration data file to configure the security system platform 100 by enabling or disabling various security system features. The customer can scale up or down the number of security system features that are enabled by simply changing the electronic device key 400.

In another embodiment, the configuration data file stored on the microprocessor 505 is encrypted. Further, the configuration data file is transmitted to the microprocessor 305 using a serial peripheral interface (SPI) communication protocol, or some other suitable communication protocol, and AES 128/256 encryption, or some other suitable encryption method.

In another embodiment, after the electronic device key 400 in connected to the interface port 310, a unique identifier is written by the microprocessor 305 to a protected memory location within the memory 520 of the microprocessor 505 (or flash memory), or a protected memory location in memory external to the microprocessor 505 and within the device key 400. The unique identifier is used configure the electronic device key 400 to function exclusively with a particular security system platform 100 (i.e. system specific). In still another embodiment, the unique identifier is used to configure the electronic device key 400 to function with any security system platform 100 (i.e. system independent).

In other embodiments, if the electronic device key 400 is disconnected from the interface port 310, an alarm is engaged, or an alert message is generated by the microprocessor 305 and displayed to the customer on a monitor, for example. This feature provides added security and prevents unauthorized removal of the electronic device key 400.

It should be noted that the depicted form factor of the electronic device key 400 is for illustrative purposes only. The electronic device key 400, in other embodiments, can be any form factor that is reasonable for the application and known to those skilled in the art. In some embodiments, the body portion 405 can be made of plastic, rubber, or metal, or any other material suitable for housing electronic components.

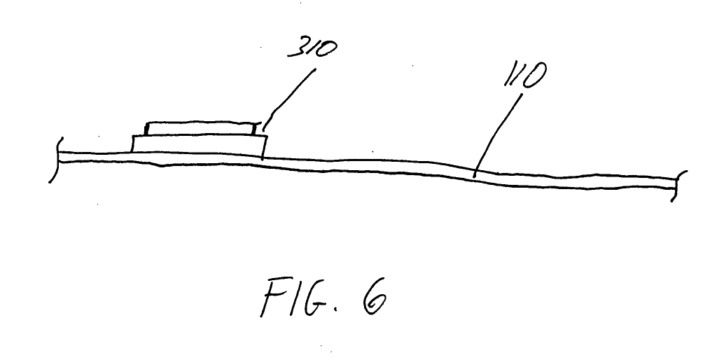

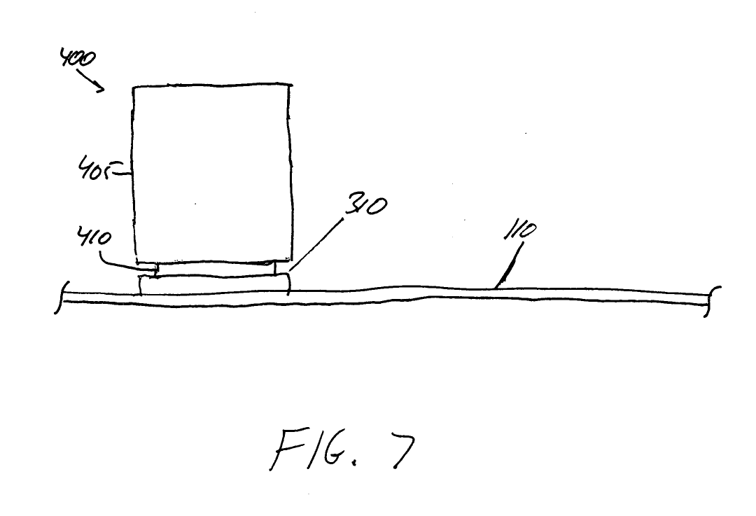

Referring to FIGS. 6 and 7, in one embodiment, the electronic device key 400 electronically mates with the interface port 310. It should be noted that the electronic device key 400 can be electrically mated with the interface port 310 in any way that is reasonable for the application and known to those skilled in the art.

Referring again to FIGS. 1 and 7, in one embodiment, in operation, the security system platform 100 is first installed at a customer site. The customer selects a particular level of security and associated security devices, such as cameras, monitors, alarms, keypads, telephone lines, wireless communication devices, and electronic door locks, for example. The particular level of security and associated security devices selected are determined by the customer's particular needs. After the customer's particular security system configuration is determined, the manufacturer stores an appropriate configuration data file in the microprocessor 505 on-chip memory 520 (or flash memory). The electronic device key 400 including the appropriate configuration data file is then mated with (connected to) the interface port 310. Thereafter, the configuration data is transmitted to the microprocessor 305. The microprocessor 305 then enables the particular features selected by the customer. The customer can add or remove security system features simply by obtaining a new electronic device key 400 from the security system manufacturer. There is no need for a technician to change the chassis 105 or the motherboard 110 for each change in the security system configuration, thus saving the customer time and expense. Further, the manufacture reduces expenses by only having to produce a single security system platform 100. The single security system platform 100 is configurable based on the customer's needs via the electronic device key 400, which includes a system configuration data file.

Variations, modifications, and other implementations of what is described herein may occur to those of ordinary skill in the art without departing from the spirit and scope of the invention. Accordingly, the invention is not to be defined only by the preceding illustrative description.

What is claimed is:

1. A system for enabling or disabling one or more security system features of a security system platform comprising:
control means configured for controlling the one or more security system features;
an interface means in communication with the control means; and
an electronic device key comprising means for storing configuration data, the electronic device key being configured to electrically mate with the interface means to establish communication between the electronic device key and the control means to transmit the configuration data to the control means to instruct the control means to enable or disable the one or more security system features of the security system platform.

2. The system of claim 1 wherein the means for storing the configuration data comprises a microprocessor.

3. The system of claim 1 wherein the means for storing configuration data comprises flash memory.

4. The system of claim 1 wherein the configuration data is encrypted.

5. The system of claim 1 wherein the electronic device key communicates with the control means via an encrypted communication protocol.

6. The system of claim 1 wherein the control means stores a unique identifier in a protected memory location on the electronic device key thereby configuring the electronic device key to function exclusively with a particular security system platform.

7. The system of claim 1 wherein the control means stores a unique identifier on the electronic device key thereby configuring the electronic device key to function with a plurality of security system platforms.

8. The system of claim 1 wherein the interface means comprises an electrical pin header.

9. The system of claim 1 wherein the interface means comprises an electrical socket.

10. The system of claim 1 wherein the control means comprises a microprocessor.

11. The system of claim 1 wherein the electronic device key comprises an electrical connector for electrically mating with the interface means.

12. An electronic device key for enabling or disabling one or more security system features of a security system platform comprising:
a body portion defining a cavity;
means for storing configuration data disposed in the cavity; and
a connector portion coupled to the body portion and in electrical communication with the means for storing configuration data, the connector portion configured to electrically mate with an interface means that is in electrical communication with a control means that controls the security system platform to communicate the configuration data to the control means to instruct the control means to enable or disable the one or more security system features of the security system platform.

13. The electronic device key of claim 12 wherein the means for storing the configuration data comprises a microprocessor.

14. The electronic device key of claim 12 wherein the means for storing configuration data comprises a flash memory.

15. A method for enabling or disabling one or more security system features of a security system platform comprising:
providing control means configured for controlling the one or more security system features;
providing interface means in communication with the control means; and
providing an electronic device key comprising means for storing configuration data, the electronic device key being configured to electrically mate with the interface means to establish communication between the electronic device key and the control means to transmit the configuration data to the control means to instruct the control means to enable or disable the one or more security system features of the security system platform.
